(19) United States
(12) Patent Application Publication
(10) Pub. No.: US 2010/0167001 A1
(43) Pub. Date: Jul. 1, 2010

(54) Antistatic Dust Cover

(76) Inventor: Tie-Jiun Wang, Taipei (TW)

Correspondence Address: FRENKEL & ASSOCIATES, 3975 UNIVERSITY DR., STE. 330, FAIRFAX, VA, 22030, US

(21) Appl. No.: 12/344,824

(22) Filed: Dec. 29, 2008

(51) Int. Cl. B32B 1/00

(52) U.S. Cl. 428/68

(57) ABSTRACT

The preferred embodiment the present invention proposes pertains to an antistatic dust cover, which is comprised of a closure base, and on the closure base is a hollow section, which is intended to accommodation the user's hand to put through it, and in turn to wipe the places that need to be wiped; a static eliminating layer, which is mounted on the closure base, which in turn is used to wipe the surface of objects containing static; and a protective membrane, which is mounted on the surface of the static eliminating layer and the proactive membrane is removed when using the unit, to achieve an aesthetical and practical functions, and rather ideal for mass production by the industry operators.

### BACKGROUND OF THE INVENTION

1. Field of the Invention

The present invention pertains to a dust cover, particularly referring to an antistatic dust cover.

2. Description of the Prior Art

Granted that static is omnipresent in our daily life, a prime examples can be found, instance, when taking off a wool sweater in a cold day, static is accumulated and discharged at the same time during the process of removing a sweater, creating the sparkling arc phenomenon we see; another example can be found in the instance where we drive to somewhere, and as the car accumulates static through its driving friction against the air, and as our human bodies can also accumulate static when the our bodies rub against the seat upholstery, static discharge often occurs at this time when we exit the car, often accompanied by a zapping sound, with slight stinging sensation. In general, the human body can perceive a static discharge exceeding 3,000 volts, and the tendency for the human body to accumulate static exceeding 6,000 to 7,000 volts or higher in dry places can often result in creating grave harm to electronic products.

The probability for electronic products to be exposed to the harm of static discharge during the fabrication, production, assembly, transportation, or even the consumer's usage processes reaches as high as one hundred percent. In light of which, the static discharge protective design technology is a requisite technology for any electronic product. Particularly so is in the case of system chipsets that are fabricated using the advanced semiconductor process, which is several tens of times smaller than the diameter of a hair, and which when exposed to static discharge, the component can be burned out by the static current, and result in a complete failure of the entire system single chipset, rendering it a major deficiency with most general electronic products.

In light of which, by focusing on the deficiency of the prior technology, the present invention has presented an antistatic dust cover that serve to fully eliminate static created by all objects, and to resolve the foregoing deficiencies that exist in the prior techniques.

### SUMMARY OF THE INVENTION

The main objective of the present invention lies in offering an antistatic dust cover, which pertains to devising a static eliminating layer on the closure base, where the static eliminating layer is saturated with antistatic liquid and wrapped with a protective membrane, which can be peeled off when in use to expose the static eliminating layer that can be used to wipe the surface of objects to achieve the intended yield of eliminating static from general objects.

One other objective of the present invention lies in offering an antistatic dust cover, in which the static eliminating layer can be made into a removable static eliminating layer, which enables the replacement of a new static eliminating layer when it is used to achieve the intended yield of repeated usage and offer effective environmental conservation.

To achieve the foresaid objectives, the present invention pertains to an antistatic dust cover, which is comprised of a closure base, and on the closure base is a hollow section, which is intended to accommodation the user's hand to put through it, and in turn to wipe the places that need to be wiped; a static eliminating layer, which is mounted on the closure base, which in turn is used to wipe the surface of objects containing static; and a protective membrane, which is mounted on the surface of the static eliminating layer and the proactive membrane is removed when using the unit, to achieve an aesthetical and practical functions, and rather ideal for mass production by the industry operators.

### BRIEF DESCRIPTION OF THE FIGURES

FIG. 1 depicts a three-dimensional dissection drawing of the invention's antistatic dust cover.

FIG. 2 depicts a three-dimensional drawing of the invention's antistatic dust cover.

FIG. 3 depicts an implementation drawing of the invention's antistatic dust cover with the protective membrane peeled off.

FIG. 4 depicts an implementation drawing of the invention's antistatic dust cover with the user's hand inserted into it.

FIG. 5 depicts yet another implementation example of the invention's antistatic dust cover wiping the surface of an object.

### REPRESENTATIVE FIGURES DESIGNATED TO THE PRESENT INVENTION

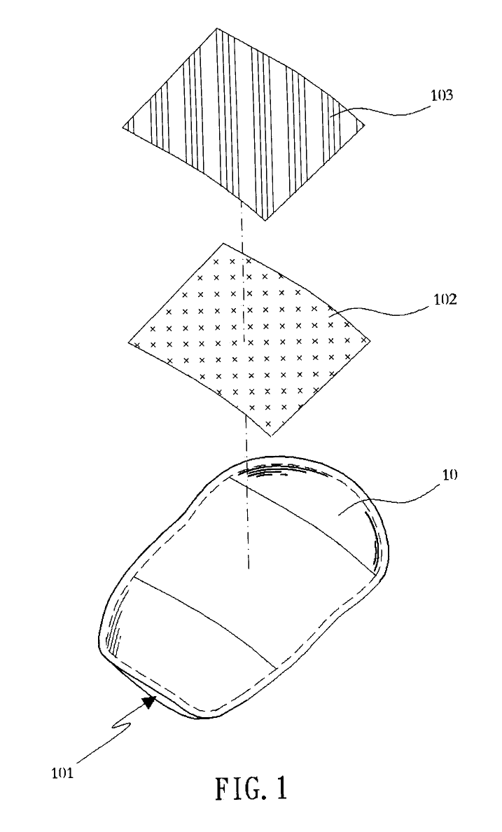

(I) The petition's designated drawing is: FIG. 1.

(II) Description for the component symbols adopted for the illustrated drawing:
10 Closure mount
101 Hollowed section
102 Static eliminating layer
103 Protective membrane

### DESCRIPTION OF SYMBOLS FOR MAJOR ELEMENTS

Closure base 10
Hollowed section 101
Static eliminating layer 102
Protective membrane 103
User's hand 20
Paper shredder 30

### DESCRIPTION OF THE PREFERRED EMBODIMENTS

The detailed descriptions of preferred embodiments set forth below in conjunction with the accompanying drawings wherein are provided for a complete and better understanding of the present invention with respect to thereof objectives, technical descriptions, feature and achieved performance, wherein:

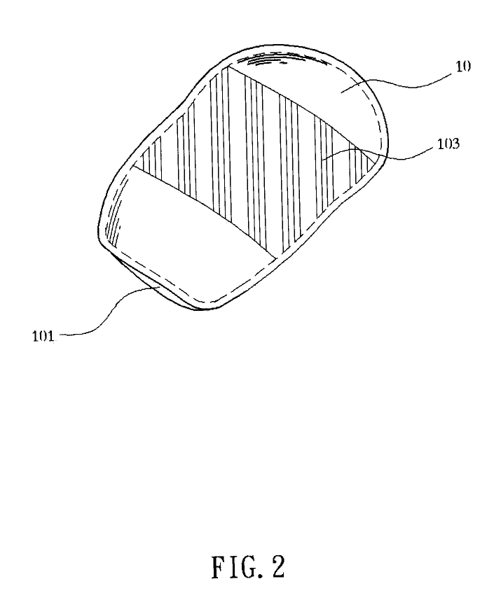

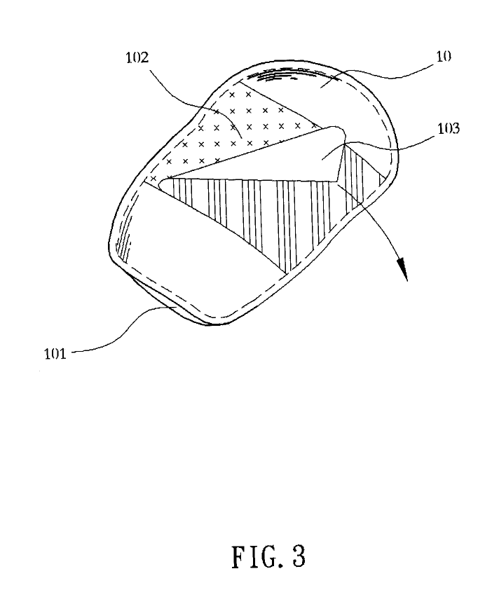

FIG. 1 depicts a three-dimensional dissection drawing of the present invention's antistatic dust cover, FIG. 2 depicts a three-dimensional drawing of the present invention's antistatic dust cover, and FIG. 3 depicts an implementation example drawing of the invention's antistatic dust cover with the protective membrane peeled off, As depicted in the drawings, a closure base 10, its configuration can be in any shape, and its material can either be in a thin plastic sheet, general fabric material or paper material, and on it is a hollow section 101, which 101 serves to facilitate accommodating the user's hand 20 to put through the hollow section, enabling the closure base 10 to attach to the user's hand 20, which would allow the user to conduct the wiping motions on the surface of objects as easily.

Also, on the surface of the closure case 10 is an antistatic eliminating layer 102, and the material of the static eliminating layer 102 can either be a sponge, general fabric material, plastic foam and so forth, where a liquid is injected into the static eliminating layer 102 that serves to eliminating static from the surface of objects effectively, reducing the potential harm of static to electrical products (not shown in the Figure), enabling a safer operating environment for electrical products and helping to extend the life cycle of electrical products (not shown in the Figure). In addition, the static eliminating layer 102 can be wrapped with a protective membrane 103, which the user can peel off the protective membrane 103 when using the product to expose the static eliminating layer 102, as it also serves to prevent the any given liquid from evaporating. Also the static eliminating layer 102 and the protective membrane 103 can be made into a replaceable mode, enabling a new static eliminating layer 102 and the protective membrane 103 be replaced onto the surface of the closure base 10 once used to achieve the objective of repetitive usage that is deemed environmentally conservative and rather suitable for mass production by the industry operators.

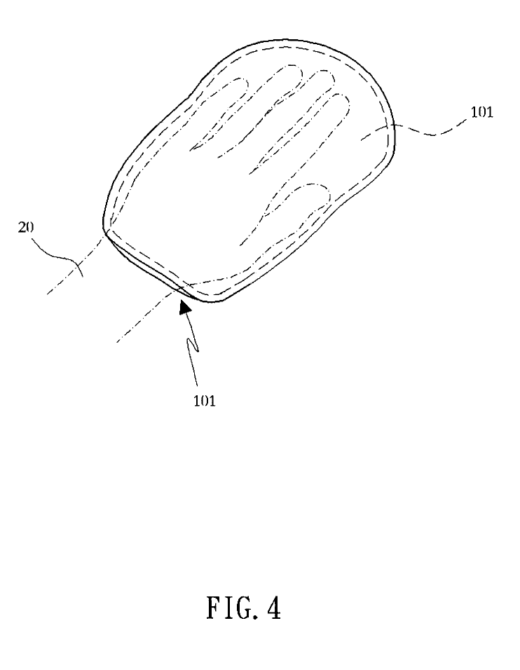

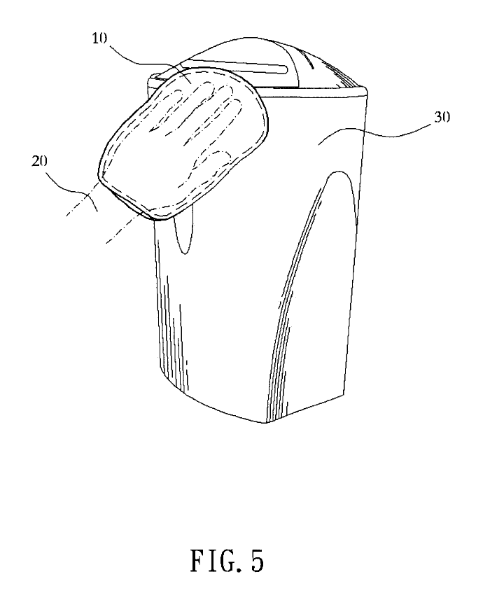

Please refer to FIG. 4 that depicts an implementation example drawing of the present invention's antistatic dust cover with the user's hand inserted and FIG. 5 that depicts yet another preferred embodiment of the present invention's antistatic dust cover used to wiping the object surface; as depicted in the drawings, firs the user's hand 20 is inserted into the hollow section 101, and the protective membrane 103 on the closure base 10 is peeled off to expose the static eliminating layer 102, which is used to conduct the wiping motion around the parameters of a paper shredder 30, serving to eliminate the static created when the paper shredder 30 is operated upon, and to effectively extend the life cycle of the paper shredder. In which, the paper shredder 30 is merely provided as an implementation example, and the present invention's antistatic dust cover can be applied in a wide variety of electrical products(not shown in the Figure), and not limited to only the paper shredder 30.

The foregoing preferred embodiments are simply to describe the technical ideas and features of the present invention while thereof objectives are to allow those people who know the said workmanship very well that can understand the contents of the present invention and put them into practice accordingly; therefore, it is intended that the descriptions of the preferred embodiments for the present invention illustrate rather than limit the present invention; that is, all the simply equivalent changes and modifications made to the spirits disclosed in the present invention shall be resided within the scope of patent set forth below for the present invention.

What is claimed is:

1. A antistatic dust cover, which at least encompasses,
A closure base, and on the closure case is a hollowed section intending as a coupler for the user's hand to pass through;
An antistatic layer, which is placed onto the closure base, and in turn can be used to wipe and remove the surface of objects containing static; and,
A protective membrane which is placed on the static eliminating layer and is peeled off when in use to expose the foresaid static eliminating layer.

2. Of the antistatic dust cover as described in claim 1 of the scope of patent application, in which the material of the static eliminating layer can be of plasticized foam.

3. Of the antistatic dust cover as described in claim 1 of the scope of patent application, in which the material of the static eliminating layer can be of a sponge.

4. Of the antistatic dust cover as described in claim 1 of the scope of patent application, in which the material of the static eliminating layer can be of a general fabric material.

5. Of the antistatic dust cover as described in claim 1 of the scope of patent application, in which the material of the protective membrane can be of a general thin plastic membrane.

6. Of the antistatic dust cover as described in claim 1 of the scope of patent application, in which the material of the protective membrane can be of a general paper-made material.

7. Of the antistatic dust cover as described in claim 1 of the scope of patent application, in which the configuration of the closure base can be in any given shape.

8. Of the antistatic dust cover as described in claim 1 of the scope of patent application, in which the material of the closure base can be of a thin plastic sheet.

9. Of the antistatic dust cover as described in claim 1 of the scope of patent application, in which the material of the closure based can be of a paper material.

10. Of the antistatic dust cover as described in claim 1 of the scope of patent application, in which the material of the closure base can be of a general fabric material.

11. Of the antistatic dust cover as described in claim 1 of the scope of patent application, in which the static eliminating layer and the protective membrane can be in a replaceable mode, allowing the used layer to be replaced with a brand-new static eliminating layer and the protective membrane, mounted onto the surface of the closure base.
